(19) United States
(12) Patent Application Publication
(10) Pub. No.: US 2013/0022852 A1
(43) Pub. Date: Jan. 24, 2013

(54) Porous Electrode with Improved Conductivity

(71) Applicants: On Kok Chang, San Jose, CA (US); Kimio Kinoshita, Cupertino, CA (US); Ronald James Mosso, Fremont, CA (US)

(72) Inventors: On Kok Chang, San Jose, CA (US); Kimio Kinoshita, Cupertino, CA (US); Ronald James Mosso, Fremont, CA (US)

(73) Assignee: EnerVault Corporation, Sunnyvale, CA (US)

(21) Appl. No.: 13/349,234

(22) Filed: Jan. 12, 2012

Related U.S. Application Data
(60) Provisional application No. 61/432,470, filed on Jan. 13, 2011.

(51) Int. Cl. H01M 4/583; H01M 4/38; H01M 4/04; H01M 4/60; B82Y 30/00

(52) U.S. Cl. 429/105; 427/113; 427/513; 156/60; 429/231.8; 429/213; 429/225; 429/222; 429/231.5; 429/210; 977/742

(57) ABSTRACT

Methods for improving the electrical conductivity of a carbon felt material is provided. In some embodiments, a method improving the electrical conductivity of a carbon felt material comprises applying a carbon source liquid to at least a portion of a carbon felt material, optionally removing excess carbon source liquid from the carbon felt material, and converting the carbon source material to solid carbon, such as by heating. Also provided are materials and products created using these methods.

### RELATED APPLICATIONS

This application claims the benefit of priority to U.S. Provisional Patent Application No. 61/432,470, filed Jan. 13, 2011, the entire contents of which are incorporated herein by reference.

### STATEMENT REGARDING FEDERALLY SPONSORED RESEARCH

Inventions included in this patent application were made with Government support under DE-OE0000225 “Recovery Act—Flow Battery Solution for Smart Grid Renewable Energy Applications” awarded by the US Department of Energy (DOE). The Government has certain rights in these inventions.

### FIELD OF THE INVENTION

This invention generally relates to porous electrode materials and more particularly to improving conductivity of carbon felt materials used as porous electrode materials in redox flow batteries.

### BACKGROUND

Reduction/oxidation (redox) flow batteries offer a large-capacity energy storage solution. Redox flow batteries are electrochemical energy storage systems which store electrical energy in chemical reactants dissolved in liquids. Liquid electrolytes are flowed through reaction cells which typically contain inert porous electrodes separated by a membrane. Such porous electrodes may use carbon or graphite materials. An example of such a flow battery system is shown in U.S. Pat. No. 4,192,910 which is incorporated herein by reference.

### SUMMARY

Carbon and graphite felts are commonly used for thermal insulation, and are therefore available relatively inexpensively. Some redox flow batteries (RFBs) also use these felts as flow-through electrodes. These felts are commonly produced from rayon or PAN (polyacrylonitrile) precursors that are converted to carbon by heat treatment at carbonizing temperatures typically >1000° C.

The individual carbon fibers in carbon or graphite felts are in physical contact but not chemically bonded. Thus a contact resistance is present at the locations where the fibers touch, and the resistance through the felt is higher than it would be if the fibers were chemically bonded to each other. A lower contact resistance within the felt is desirable when such felts are used as electrodes in Redox Flow Batteries (RFBs). Such a reduced contact resistance results in lower cell resistance and higher voltaic efficiency for the flow battery.

### BRIEF DESCRIPTION OF DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a perspective view of intersecting fibers in a carbon felt matrix.

FIG. 2 is a perspective view of intersecting fibers in a carbon felt matrix with droplets of a carbon source liquid at fiber junctions.

FIG. 3 is a flow chart illustrating a process for improving the electrical conductivity of a carbon felt material.

FIG. 4 is a schematic illustration of a flow battery system.

FIG. 5 is a cross-sectional illustration of a single electrochemical cell that may be used as part of a flow battery system.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The electrical conductivity of a carbon felt material may be enhanced by incorporating a carbon-based additive that reduces the contact resistance at junctions of intersecting fibers within the felt. In some embodiments, a liquid containing a carbon source may be applied to the felt to wet the fiber surfaces and collect at the contact points where the fibers touch each other. Excess liquid may be drained from the felt, and the carbon felt with the liquid carbon source may be heated in an inert environment to convert the liquid carbon source into substantially conductive solid or porous carbon. The carbon in the vicinity of the contact points will increase the contact area and/or form a chemical bond between the fibers to improve the electrical conductivity of the felt.

As used herein, the phrase “carbon felt” may refer to any carbon felt or graphite material available to the skilled artisan. In some embodiments, carbon felts refers to carbon materials formed at carbonizing and graphitizing temperatures from PAN (polyacrylonitrile), rayon or other similar felts.

Liquids containing a suitable carbon source are available in many common organic compounds. Some desirable properties of suitable carbon source materials include: a high boiling point; a high C/H ratio; a high C/O ratio; and a high C/N ratio. In other words, it is desirable in some embodiments for the carbon content of a carbon source liquid to be sufficiently high such that carbonization occurs with a minimal weight loss.

Examples of suitable carbon source liquids include acrylonitrile, phenols and others. In some embodiments, the carbon source may be reactive, such as a monomeric compound that polymerizes to a polymer with high thermal stability suitable for carbonization. In some embodiments of a one-component carbon source liquid, a monomer reacts with itself to form a homopolymer, e.g., acrylate esters and cyanoacrylate esters. In alternative embodiments, carbon source liquids may include two or more polymerizing components. For example, in some embodiments of a two-component carbon source, a monomer reacts with another monomer to from a heteropolymer. Such embodiments may include bisphenol-A with epi-chlorohydrin, epoxide with aromatic amines, and phenols with formaldehyde. Other embodiments will also be apparent to the skilled artisan in view of this disclosure.

In some embodiments, two-component carbon sources may polymerize at a lower temperature than one-component carbon sources. Some two-component carbon sources polymerize at room temperature. In some embodiments, carbon source materials may be thinned as needed in a solution of a suitable solvent. Once the solvent vaporizes and the monomers are in intimate contact, polymerization will occur. In either one-component or the two-component systems, multi-functional monomers may be used to achieve crosslinking of the polymer, which may increase the thermal stability.

In alternative embodiments, a carbon source liquid may be a substantially non-reactive compound. Such non-reactive carbon source liquids may include aqueous or other solutions containing dissolved sugars, heavy oils, and some polymer solutions. Other embodiments of both reactive and non-reactive carbon source liquids will also be apparent to the skilled artisan.

In other embodiments, a carbon source material may be supplemented by including a powder of conductive particles to a suitable precursor liquid such as the carbon source liquids discussed above. One advantage of adding conductive particles to a carbon source liquid is that a conductivity value similar to a high-temperature material can be obtained at a lower processing temperature without risk of overheating the original felt material. In some embodiments, such particles may include carbon particles such as powdered graphite or carbon black (e.g., KETJENLACK® produced by AKZO NOBEL N.V.). In other embodiments, other electrically conductive particles may be added to a suitable precursor liquid. For example in some embodiments, electrically conductive particles added to a carbon source liquid may include metallic filings, carbon nanotubes or other particles.

In embodiments in which metal filings are added to improve conductivity of a felt to be used as a flow-through electrode in an electrochemical system, it is preferable to add particles of a metal with a neutral or beneficial electrochemical impact on the relevant oxidation and/or reduction reactions. For example, in some embodiments, particles of conductive reaction catalysts or reaction suppressants may be added. In the case of an Fe/Cr flow battery system, such catalysts and/or reaction suppressants may include materials such as lead (Pb), bismuth (Bi), gold (Au), cadmium (Cd), titanium (Ti), zirconium carbide (ZrC), other carbide or nitride compounds, or any other catalyst or reaction suppressant as desired. Thus, in some embodiments, particles of such materials may be added to a carbon source liquid for further improving the conductivity of a carbon felt material as described herein.

In some embodiment, a liquid carbon source may be applied to a carbon felt material by immersing the carbon felt in the liquid. In other embodiments, a liquid carbon source may be pumped through, poured over, or sprayed onto or otherwise applied to the felt. In some embodiments, the carbon source liquid may be applied to the entire carbon felt material. In alternative embodiments, the carbon source liquid may be applied only to selected portions of the carbon felt material.

Once a sufficient quantity of liquid has been applied to the felt, the felt may be removed from the liquid and excess liquid may be removed. For example, in some embodiments excess liquid may be wiped off, allowed to drip off by gravity, removed by suction, by shaking, by spinning or other means.

After removing excess carbon source liquid from the felt, the carbon felt and remaining liquid may be heat treated to substantially convert the carbon source to carbon. In some embodiments, a polymerizing carbon source material may be allowed to harden prior to heat treating. In other embodiments, a carbon source may be cured, such as by exposing it to an ultraviolet light prior to heat treating.

Heat treating may be performed by placing the carbon felt in a high-temperature oven at a sufficient temperature and for a sufficient time to substantially convert the remaining carbon source material to solid carbon, such as by pyrolysis. Such temperatures and times may vary depending on physical and chemical characteristics of the carbon source material and/or the carbon felt material. Heat treating may also be performed through the use of open flame, microwaves, ultrasound or other processes. In some embodiments, the resulting carbon may be substantially dense solid carbon, while in other embodiments, the resulting carbon may be substantially porous solid carbon. Selection or composition of a carbon source material and processing parameters may be adjusted to achieve a desired resulting carbon density.

In some embodiments, a carbon source may have relatively high oxygen content. During heat treatment of such materials, some of the oxygen may react chemically with carbon and increase the surface roughness. The net result is a carbon felt with higher surface area, which may be beneficial in flow-through electrodes.

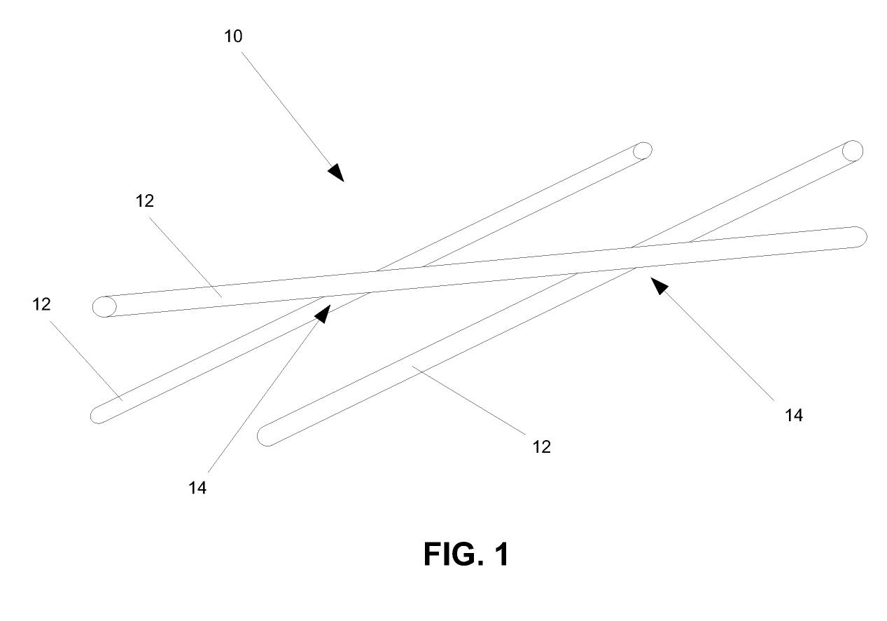

Further embodiments will now be described with reference to FIGS. 1-3. FIG. 1 illustrates a simplified section of carbon felt 10 with fibers 12 overlapping at junctions 14. Due to the relatively small contact surface area at the junctions 14, electrical conductivity from one fiber 12 to the next is relatively low.

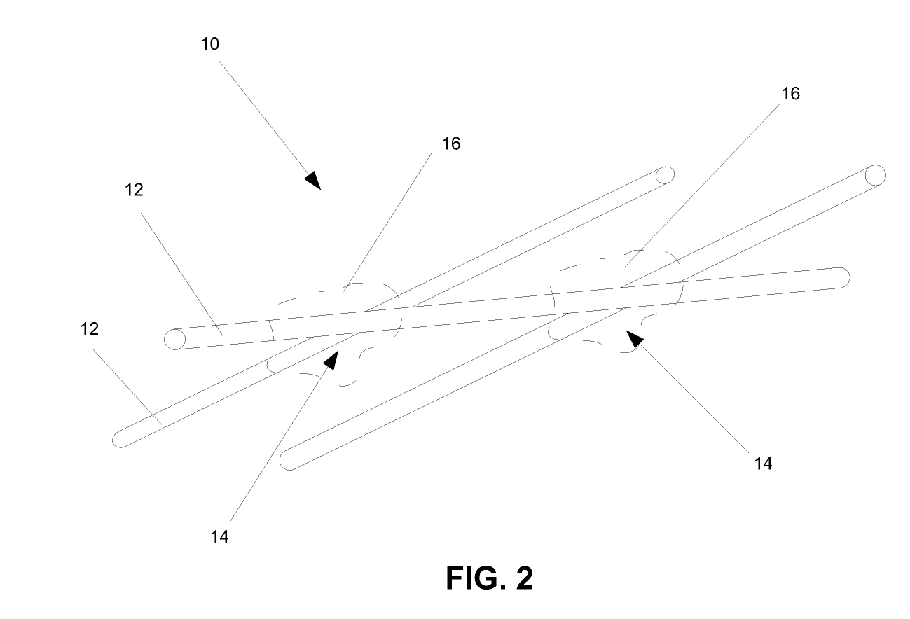

FIG. 2 illustrates the same overlapping fibers 12 after contact with a carbon source liquid. Cohesion of the liquid will tend to cause droplets 16 of the carbon source liquid to remain at the junctions 14. The carbon felt 10 and carbon source liquid droplets 16 may then be heated to a sufficient temperature for a sufficient time to substantially convert the carbon source to solid carbon of a desired density, leaving larger areas of carbon at intersections and increasing electrical conductivity from one fiber to connecting fibers 12.

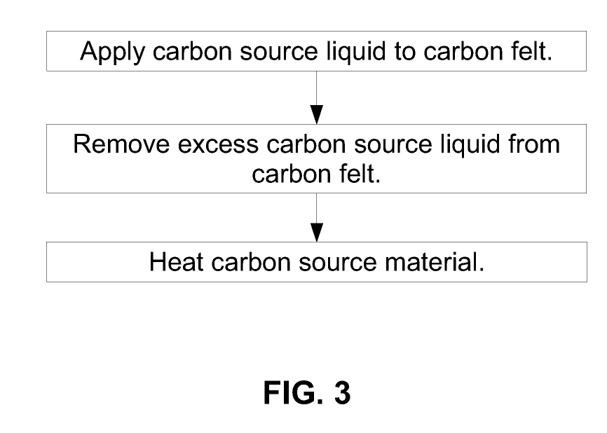

FIG. 3 is a flow chart illustrating one embodiment of a method for improving the electrical conductivity of a carbon felt material. In the illustrated embodiment, the method comprises applying a carbon source liquid to a carbon felt material. This may be achieved by any suitable method. If necessary, excess carbon source liquid may then be removed from the carbon felt material. In some embodiments, the step of removing excess carbon source liquid from the carbon felt material may be omitted. Such embodiments may include cases in which the carbon source liquid has a substantially low viscosity or the method of applying carbon source liquid leaves a minimal amount of excess liquid, thereby obviating the need to remove excess liquid. With a desired quantity of carbon source liquid on the carbon felt material, at least the carbon source liquid may be heated by any suitable means until the carbon source liquid is substantially converted to solid carbon.

In some embodiments, carbon felt materials prepared according to any of the foregoing embodiments may be used as a porous electrode material in a redox flow battery. In some embodiments, such porous electrodes may further comprise one or more additional coatings of metallic or other materials to promote or suppress chemical reactions occurring within a redox flow battery reaction cell. Some embodiments of such electrodes and catalyst coatings are described in U.S. Pat. No. 4,192,910.

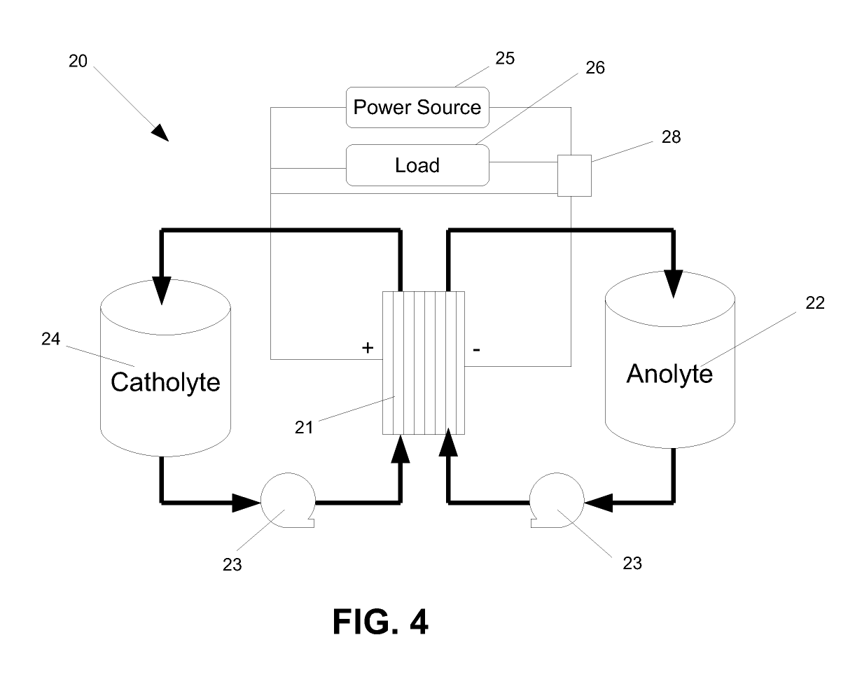

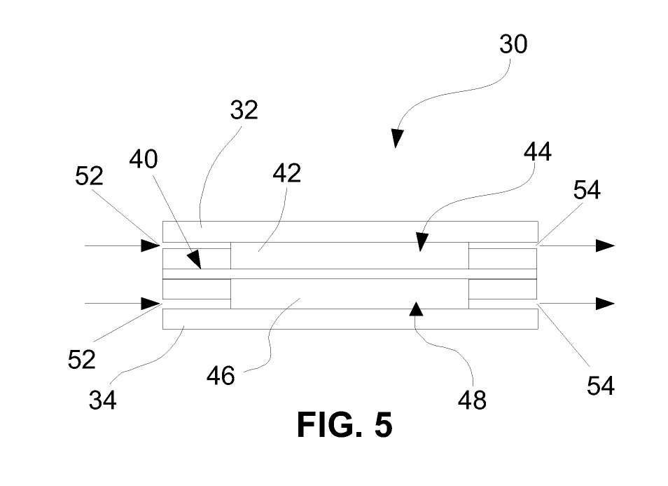

Carbon felt materials treated according to any of the embodiments above may be used as flow-through electrodes in any suitable electrochemical system, some examples of which are illustrated in FIGS. 4-5.

FIG. 4 illustrates a typical redox flow battery system 20 comprising an electrochemical stack assembly 21 which may be configured to convert electrical energy from an electric power source 25 into chemical potential energy in liquid electrolytes flowed through the stack assembly 21 by pumps 23 and stored in tanks containing negative electrolyte (anolyte) 22 and positive electrolyte (catholyte) 24. The stack assembly 21 may also be configured to convert chemical potential energy into electric power for delivery to an electric load 26.

In some embodiments an electronic control system 28 may control the switching of charging from a source 25 and discharging to a load 26, as well as controlling the battery's operation mode and other control functions. In some embodiments, the stack assembly 21 may comprise a plurality of individual electrochemical reaction cells joined hydraulically and electrically in parallel and/or series combinations in order to meet design objectives. Some examples of such stack assemblies are shown and described in U.S. Pat. No. 7,820,321 and US Patent Application Publication No. 2011/0223450, both of which are incorporated herein by reference.

Although the redox flow battery system of FIG. 4 is shown with two tanks, flow battery systems may also use four tanks. In some embodiments, the benefits of a four-tank system may be achieved by using two tanks, each having a divider. Examples of redox flow battery systems with divided tanks are shown and described in U.S. Pat. No. 7,820,321.

FIG. 5 illustrates an example of a single electrochemical reaction cell 30 with a first current collector plate (also referred to as a “bipolar plate”) 32, a second current collector plate 34, a separator membrane 40, a first electrode chamber 42 with a first porous electrode 44, and a second electrode chamber 46 with a second porous electrode 48. Each electrode chamber 42, 46 has an electrolyte inlet 52 and an electrolyte outlet 54. For convenience of discussion, the first porous electrode 44 will be referred to as the positive electrode 44, and the second porous electrode 48 will be referred to as the negative electrode 48. In some embodiments, each individual cell within a flow battery stack assembly may include at least these components.

In some embodiments, the current collector plate may be made of a substantially electrically conductive, but non-reactive material. In some embodiments, a solid carbon plate may be used as a current collector plate. In other embodiments, a current collector plate may comprise a conductive polymer material, or a composite polymer material with carbon or other electrically conductive additives.

In operation, electrolytes may be pumped from the tanks into a cell via the electrolyte inlet 52, through the porous electrodes, 44, 48, and out of the cell via the electrolyte outlet 54. During a normal charging operation, flow battery reactants take up energy by oxidizing a reactant species in the catholyte at the positive electrode (cathode) and by reducing a reactant species in the anolyte at the negative electrode (anode). During a discharge cycle of the same redox flow battery, reactants release energy by reducing a reactant species in the catholyte at the positive electrode and oxidizing a reactant species in the anolyte at the negative electrode.

During charging and discharging, electric currents flow through the material of the conductive porous electrodes 44, 48, and through the current collector plates 32, 34 to which additional electrical conductors may be connected to complete a circuit. Thus, in some embodiments overall voltaic efficiency of a flow battery system may be improved by using porous conductive felt electrodes treated by the above-described processes to improve their internal conductivity. Examples of such flow battery systems include iron-chrome, iron-tin, iron-manganese, vanadium-iron, all-vanadium, iron-bromide, and polysulfide bromide.

In some embodiments, a porous carbon electrode may be bonded to a current collector plate using a similar pyrolizing process to that described above. For example in some embodiments, a suitable carbon source liquid (with or without the addition of conductive particles) may be deposited onto a surface of a current collector plate material, and a carbon felt material may be placed onto the plate. If desired, a carbon source liquid may be cured or allowed to polymerize to a solid. The felt and plate assembly may then be heated as described above in order to pyrolyze the carbon source while simultaneously substantially bonding the felt to the plate and improving the electrical conductivity of the entire assembly. In some embodiments, carbon felt may be bonded to both sides of a carbon plate using such a procedure.

Improved flow-through electrodes may also be used with hybrid flow battery systems in which one or more electroactive component is plated as a solid. Examples of hybrid flow batteries include zinc-bromine zinc-cerium, and lead-acid flow batteries.

The improved-conductivity carbon felt materials described herein may also be used with any other electrochemical system that uses an electrically conductive flow-through electrode. For example, flow-through electrodes are also used in cells for the electrochemical synthesis of chemicals such as chlor-alkali. Conductive flow-through electrodes are also used in electrochemical purification systems. Some types of fuel cells (e.g., direct-methanol fuel cells) can also use conductive flow-through electrodes. Any of these or other systems may use improved carbon felt electrodes as described herein.

By virtue of the foregoing, the present disclosure provides a method of improving electrical conductivity of a carbon felt material by applying a carbon source liquid to at least a portion of a carbon felt material, and converting the applied carbon source liquid to solid carbon. In an embodiment, the method further includes removing excess carbon source liquid from the at least a portion of the carbon felt prior to converting the applied carbon source liquid to solid carbon. In an embodiment, the applied carbon source liquid may be converted to solid carbon by heating the applied carbon source liquid in an inert environment. Alternatively or in addition, the applied carbon source liquid may be polymerized prior to converting the carbon source liquid to solid carbon. Alternatively or in addition, the applied carbon source liquid may be hardened by illuminating the material with an ultraviolet light prior to converting the applied carbon source liquid to solid carbon.

In an embodiment, the carbon source liquid is selected from the group consisting of acrylonitrile, a phenol, an acrylate ester, a cyanoacrylate ester, a combination of bisphenol-A with epi-chlorohydrin, a combination of epoxide with an aromatic amine, and a combination of a phenol with formaldehyde. In an exemplary embodiment, the carbon source liquid further comprises a solvent that prevents polymerization of the carbon source liquid prior to applying the carbon source liquid to the at least a portion of a carbon felt material. In addition, the carbon source liquid may have a boiling point temperature greater than that of the solvent.

In some embodiments, the method may further include adding conductive particles to the carbon source liquid prior to applying the carbon source liquid to the at least a portion of a carbon felt material. In an exemplary embodiment, the conductive particles are selected from the group consisting of powered graphite, carbon black, metallic filings, and carbon nanotubes. Alternatively, the conductive particles may be selected from the group consisting of lead, bismuth, gold, cadmium, titanium, and zirconium carbide. In an embodiment, the conductive particles may include a selected one of a reaction catalyst and a reaction suppressant.

In an embodiment, the method may further include bonding the carbon felt material to a bipolar plate.

In an embodiment, the carbon source liquid may comprise an amount of oxygen sufficient to chemically interact with carbon during heating to produce surface roughness.

In various embodiments, the carbon source liquid may comprise an aqueous solution.

In an embodiment, a porous electrode may include a carbon felt material and a carbon layer formed by applying a carbon source liquid on at least a portion of the carbon felt material and converting the applied carbon source liquid to solid carbon. In various embodiments, the carbon source liquid may be selected from a group consisting of acrylonitrile, a phenol, an acrylate ester, a cyanoacrylate ester, a combination of bisphenol-A with epi-chlorohydrin, a combination of epoxide with an aromatic amine, and a combination of a phenol with formaldehyde. Alternatively or in addition, the carbon layer further may include conductive particles added to the carbon source liquid prior to applying the carbon source liquid to the at least a portion of a carbon felt material. In various exemplary embodiments, the conductive particles may be selected from a group consisting of powered graphite, carbon black, metallic filings, carbon nanotubes, lead, bismuth, gold, cadmium, titanium, and zirconium carbide. Alternatively or in addition, the conductive particles may include one of a reaction catalyst and a reaction suppressant.

In an embodiment, the porous electrode may further include a bipolar plate bonded to the carbon felt material.

In an embodiment, a reduction-oxidation (redox) cell may include a first chamber containing a first liquid electrolyte, and a first porous electrode. The first porous electrode is preferrably electrically conductive and chemically inert with respect to the first liquid electrolyte. The first porous electrode may include a carbon felt material, and a carbon layer formed by applying a carbon source liquid on at least a portion of the carbon felt material and converting the applied carbon source liquid to a solid carbon.

In various embodiments, the redox cell may further includes a second chamber containing a second liquid electrolyte, an ion permeable membrane separating the first and second chambers, and a second porous electrode in the second chamber, the second porous electrode being electrically conductive and chemically inert with respect to the second liquid electrolyte. The second porous electrode may include a carbon felt material, and a carbon layer formed by applying a carbon source liquid on at least a portion of the carbon felt material and converting the applied carbon source liquid to a solid carbon. A selected one of the first and second liquid electrolytes may be an anode fluid while the other one may be a cathode fluid.

In an exemplary embodiments, the carbon source liquid may have a physical property selected from a group consisting of a high carbon/hydrogen (C/H) ratio, a high carbon/oxygen (C/O) ratio, and a high carbon/nitrogen (C/N) ratio that are selected to result in most of the carbon source liquid converting to solid carbon by weight.

In an embodiment, a method for manufacturing a porous electrode may include polymerizing the applied carbon source liquid in an atmosphere greater than two times atmospheric pressure to mitigate vaporization of the applied carbon source liquid.

In various embodiments, the carbon source liquid may be selected to substantially convert to solid carbon. For example, the carbon source liquid may have a boiling point temperature greater than 125° C. at one atmospheric pressure. For another example, the carbon source liquid may have a carbon/hydrogen (C/H) atomic ratio greater than 0.85, excluding any solvent. As another example, the carbon source liquid may have a carbon/oxygen (C/O) atomic ratio that is greater than 2.5, excluding any solvent. For a further example, the carbon source liquid may have a carbon/nitrogen (C/N) atomic ratio that is greater than 4, excluding any solvent.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

What is claimed is:

1. A method of improving electrical conductivity of a carbon felt material, the method comprising:
applying a carbon source liquid to at least a portion of a carbon felt material; and
converting the applied carbon source liquid to solid carbon.

2. The method of claim 1, further comprising removing excess carbon source liquid from the at least a portion of the carbon felt material prior to converting the applied carbon source liquid to solid carbon.

3. The method of claim 1, wherein converting the applied carbon source liquid to solid carbon comprises heating the applied carbon source liquid in an inert environment.

4. The method of claim 1, further comprising polymerizing the applied carbon source liquid prior to converting the carbon source liquid to solid carbon.

5. The method of claim 4, further comprising polymerizing the applied carbon source liquid in an atmosphere greater than two times atmospheric pressure to mitigate vaporization of the applied carbon source liquid.

6. The method of claim 1, further comprising hardening the applied carbon source liquid by exposing it to ultraviolet light prior to converting the applied carbon source liquid to solid carbon.

7. The method of claim 1, wherein the carbon source liquid is selected from a group consisting of acrylonitrile, a phenol, an acrylate ester, a cyanoacrylate ester, a combination of bisphenol-A with epi-chlorohydrin, a combination of epoxide with an aromatic amine, and a combination of a phenol with formaldehyde.

8. The method of claim 7, wherein the carbon source liquid further comprises a solvent that prevents polymerization of the carbon source liquid prior to applying the carbon source liquid to the at least a portion of a carbon felt material.

9. The method of claim 1, wherein the carbon source liquid has a boiling point temperature greater than 125° C. at one atmosphere pressure.

10. The method of claim 1, wherein the carbon source liquid has a carbon/hydrogen (C/H) atomic ratio greater than 0.85, excluding any solvent.

11. The method of claim 1, wherein the carbon source liquid has a carbon/oxygen (C/O) atomic ratio that is greater than 2.5, excluding any solvent.

12. The method of claim 1, wherein the carbon source liquid has a carbon/nitrogen (C/N) atomic ratio that is greater than 4, excluding any solvent.

13. The method of claim 1, further comprising adding conductive particles to the carbon source liquid prior to applying the carbon source liquid to the at least a portion of a carbon felt material.

14. The method of claim 13, wherein the conductive particles are selected from a group consisting of powered graphite, carbon black, vapor grown carbon fiber, metallic filings, and carbon nanotubes.

15. The method of claim 13, wherein the conductive particles are selected from a group consisting of lead, bismuth, gold, cadmium, titanium, and zirconium carbide.

16. The method of claim 13, wherein the conductive particles comprise a selected one of a reaction catalyst and a reaction suppressant.

17. The method of claim 1, further comprising bonding the carbon felt material to a bipolar plate.

18. The method of claim 1, wherein the carbon source liquid comprises an amount of oxygen sufficient to chemically interact with carbon during heating to produce surface roughness.

19. The method of claim 1, wherein the carbon source liquid comprises an aqueous solution.

20. A porous electrode, comprising:
a carbon felt material; and
a carbon layer formed by applying a carbon source liquid on at least a portion of the carbon felt material and converting the applied carbon source liquid to solid carbon.

21. The porous electrode of claim 20, wherein the carbon source liquid is selected from a group consisting of acrylonitrile, a phenol, an acrylate ester, a cyanoacrylate ester, a combination of bisphenol-A with epi-chlorohydrin, a combination of epoxide with an aromatic amine, and a combination of a phenol with formaldehyde.

22. The porous electrode of claim 20, wherein the carbon layer further comprises conductive particles added to the carbon source liquid prior to applying the carbon source liquid to the at least a portion of a carbon felt material.

23. The porous electrode of claim 22, wherein the conductive particles are selected from a group consisting of powered graphite, carbon black, metallic filings, carbon nanotubes, lead, bismuth, gold, cadmium, titanium, and zirconium carbide.

24. The porous electrode of claim 23, wherein the conductive particles comprise a selected one of a reaction catalyst and a reaction suppressant.

25. The porous electrode of claim 20, further comprising a bipolar plate bonded to the carbon felt material.

26. A reduction-oxidation (redox) cell, comprising:
a first chamber containing a first liquid electrolyte; and
a first porous electrode in the first chamber, the first porous electrode being electrically conductive and chemically inert with respect to the first liquid electrolyte, wherein the first porous electrode comprises:
a carbon felt material, and
a carbon layer formed by applying a carbon source liquid on at least a portion of the carbon felt material and converting the applied carbon source liquid to a solid carbon.

27. The redox cell of claim 26, further comprising:
a second chamber containing a second liquid electrolyte;
an ion permeable membrane separating the first and second chambers; and
a second porous electrode in the second chamber, the second porous electrode being electrically conductive and chemically inert with respect to the second liquid electrolyte, wherein the second porous electrode comprises:
a carbon felt material, and
a carbon layer formed by applying a carbon source liquid on at least a portion of the carbon felt material and converting the applied carbon source liquid to a solid carbon,
wherein a selected one of the first and second liquid electrolyte comprises an anode fluid and the other one comprises a cathode fluid.

28. The redox cell of claim 26, wherein the carbon source liquid has a physical property selected from a group consisting of a high carbon/hydrogen (C/H) ratio, a high carbon/oxygen (C/O) ratio, and a high carbon/nitrogen (C/N) ratio that are selected to result in most of the carbon source liquid converting to solid carbon by weight.
